(19) United States
(12) Patent Application Publication
(10) Pub. No.: US 2002/0087462 A1
(43) Pub. Date: Jul. 4, 2002

(54) Method and system for electronic transfer of funds implementing an automated teller machine in conjunction with a manned kiosk

(75) Inventors: Dean A. Seifert, Parker, CO (US); Earney E. Stoutenburg, Highlands Ranch, CO (US)

Correspondence Address: Mark E. Stuenkel, Brooks & Kushman P.C., Twenty-Second Floor, 1000 Town Center, Southfield, MI, 48075, US

(73) Assignee: First Data Corporation, Hackensack, NJ (US)

(21) Appl. No.: 09/751,120

(22) Filed: Dec. 28, 2000

(51) Int. Cl. G06F 17/60

(52) U.S. Cl. 705/39

(57) ABSTRACT

A method for electronically transferring funds between a sender and a recipient includes receiving at an initiating terminal a designation of an amount of funds to be electronically transferred from the sender; receiving at the initiating terminal a security code from the sender; generating a unique personal identification number; providing the unique personal identification number to the sender; storing the designation of an amount of funds, the security code and the unique personal identification number at a central terminal in communication with the initiating terminal; providing a manned kiosk including a kiosk agent; receiving the unique personal identification number and the security code at the manned kiosk from the recipient; communicating the unique personal identification number and the security code provided by the recipient to the central terminal; comparing the unique personal identification number and the security code provided by the recipient to the stored unique personal identification number and stored security code at the central terminal; and dispensing funds corresponding to the designation of an amount of funds at the manned kiosk by the kiosk agent if the unique personal identification number and the security code provided by the recipient match the stored unique personal identification number and the stored security code.

### TECHNICAL FIELD

The present invention relates generally to the electronic transfer of funds, and more particularly to a method and system for electronic transfer of funds using an automated teller machine in conjunction with a manned kiosk.

### BACKGROUND ART

“Money wiring” transactions are widely used to electronically transfer funds from one point to another distant location through a financial services institution. Many such transactions are also facilitated by other businesses, companies or organizations that act as agents of the financial services institution.

In a typical “money wiring” transaction, a customer (hereinafter referred to as “sender”) enters an agent location, presents cash or cash equivalent in the amount of the principal to be transferred plus a service or convenience fee, provides the agent the name of the person to whom the money is to be sent (hereinafter referred to as “recipient”), and is issued a receipt. The agent then typically registers the transaction on a computer, which automatically updates a central computer system of the financial services institution. To receive the money, the recipient must typically go to another agent location, show proper identification (e.g., valid driver's license or military ID), and identify the source of the money, the sender's name, and how much is to be sent.

U.S. Pat. No. 5,650,604 discloses another method for electronically transferring funds between a sender and a recipient. Under this method, the sender initiates a money transfer transaction at an automated initiating terminal, and the recipient receives transferred funds at an automated dispensing terminal. Although this method is efficient and fully automated, this method is not useful for recipients who are either not familiar with or comfortable with the associated technology.

### DISCLOSURE OF INVENTION

The present invention addresses the shortcomings of the prior art by providing a location flexible method for electronically transferring funds that affords a recipient personal service in receiving funds.

Under the invention, a method is provided for electronically transferring funds between a sender and a recipient that includes receiving at an initiating terminal a designation of an amount of funds to be electronically transferred from the sender; receiving at the initiating terminal a security code from the sender; generating a unique personal identification number; providing the unique personal identification number to the sender; storing the designation of an amount of funds, the security code and the unique personal identification number at a central terminal in communication with the initiating terminal; providing a manned kiosk including a kiosk agent; receiving the unique personal identification number and the security code at the manned kiosk from the recipient; communicating the unique personal identification number and the security code provided by the recipient to the central terminal; comparing the unique personal identification number and the security code provided by the recipient to the stored unique personal identification number and stored security code at the central terminal; and dispensing funds corresponding to the designation of an amount of funds at the manned kiosk by the kiosk agent if the unique personal identification number and the security code provided by the recipient match the stored unique personal identification number and the stored security code.

Further under the invention, a system for performing an electronic transfer of funds transaction between a sender and a recipient includes an initiating terminal for receiving a designation of funds to be electronically transferred from the sender to the recipient, and for receiving a security code from the sender. A central terminal is in communication with the initiating terminal for providing the initiating terminal with a unique personal identification number corresponding to the electronic transfer of funds transaction, and for storing the designation of funds, the unique personal identification number and the security code. The system further includes a manned kiosk in communication with the central terminal. The manned kiosk includes an agent for receiving the unique personal identification number and the security code from the recipient, and for communicating the unique personal identification number and the security code provided by the recipient to the central terminal. Furthermore, the central terminal is operative to compare the unique personal identification number and the security code provided by the recipient with the stored unique personal identification number and the stored security code. The manned kiosk is operative to dispense funds corresponding to the designation of funds directly to the recipient when the unique personal identification number and the security code provided by the recipient match the stored unique personal identification number and the stored security code.

Advantageously, the method and system of the invention provide senders with the flexibility of transferring funds from a variety of locations to a manned kiosk, which provides recipients personal service. This invention is therefore appealing to those recipients that are either not familiar with or comfortable with the technology of electronically transferring funds. Furthermore, by providing multiple manned kiosks over a large are, the availability of receive locations may be increased substantially.

These and other objects, features, and advantages of the present invention are readily apparent from the following detailed description of the best modes for carrying out the invention when taken in connection with the accompanying drawings.

### BRIEF DESCRIPTION OF DRAWINGS

FIG. 1 is a schematic diagram of an example system according to the invention for performing an electronic transfer of funds transaction that includes an initiating transaction and a dispensing transaction;

FIG. 2 is a block diagram illustrating method steps of the initiating transaction; and

FIG. 3 is a block diagram illustrating method steps of the dispensing transaction.

### BEST MODES FOR CARRYING OUT THE INVENTION

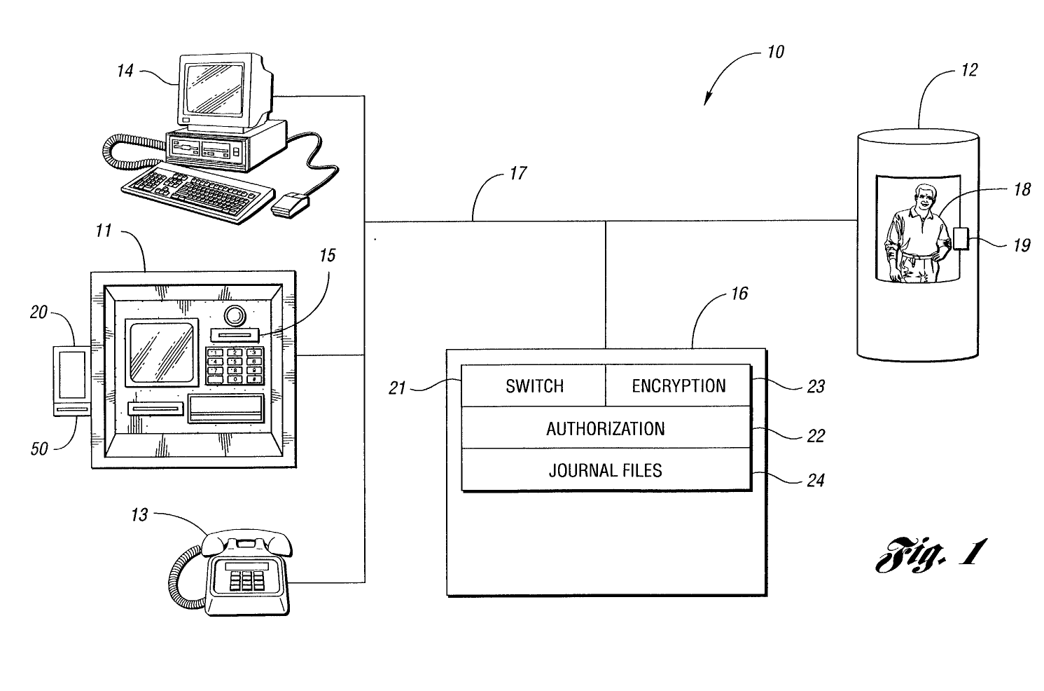

FIG. 1 illustrates a system 10 according to the present invention for electronically transferring funds from a sender to a recipient using an initiating terminal, such as an automated teller machine (ATM) 11, and a manned kiosk 12, which is used to dispense funds to the recipient. Because the system 10 includes the manned kiosk 12, the present invention provides personal service to the recipient who may not be familiar with and/or comfortable with technology associated with automated terminals such as ATMs. Furthermore, by employing an ATM 11, or other suitable initiating terminal, to initiate the transfer of funds, the sender is afforded great flexibility in initiating money transfer transactions. For example, the sender may initiate transactions from a variety of locations, twenty-four hours a day, seven days a week. FIG. 1 also illustrates other examples of initiating terminals that may be used to practice the present invention, including a telephone terminal 13 or a personal computer 14.

At the initiating terminal 11, 13, 14, the sender provides transaction information, which may include, but is not limited to, a security code, an account number of an account from which funds are to be transferred, and a designated or desired amount of funds to be transferred, which may also be referred to as a principal amount. Preferably, the initiating terminal 11, 13, 14 prompts the sender for the transaction information. In the case of a telephone-type initiating terminal 13, the sender may dial into a voice response unit (hereinafter referred to as “VRU”) that prompts the sender verbally to provide transaction information. As another example, a telephone-type initiating terminal 13 may be configured as a screen phone with graphical user interface (GUI) for prompting and receiving the transaction information. Similarly, a personal computer-type initiating terminal 14 may be provided with GUI for prompting and receiving the transaction information. Alternatively, the initiating terminal may be any other suitable terminal.

Initiating terminal 11, 13, 14 also preferably includes a financial card reader 15 for reading information, such as account number and identification number, from a financial card, such as a credit card, debit card, smart card or stored value card. The initiating terminal 11, 13, 14 also preferably encrypts the information so as to ensure security during transmission of the information. If the initiating terminal is not an ATM 11 which is customarily DES-secure, then it preferably includes a device attached to the communication line that securely encrypts information. Such a device may be attached to a telephone, screen phone, television setup box, personal computer, etc. and permits secure financial transactions from various locations.

A central terminal 16 is in communication with the initiating terminal 11, 13, 14 via a communication network 17, which may be any suitable network such as a local area network, a wide area network, a dial-up network, the Internet, a wireless network, or any combination thereof. The central terminal 16 is preferably a host computer that is operated by a financial services institution engaged in the business of providing money transfer transactions. The central terminal 16 receives the transaction information from the initiating terminal 11, 13, 14, and is operative to verify that the principal amount, as well as any transaction or convenience fee, is available in the sender's account. The central terminal 16 may include an authorization engine or agent for performing such verification, or the central terminal 16 may communicate with one or more other authorization agents. The central terminal 16 also generates a unique personal identification number (PIN) if the principal amount is verified or otherwise authorized.

As mentioned above, the manned kiosk 12 is used to dispense funds to the recipient. The manned kiosk 12 includes a kiosk agent 18 and a dispensing terminal 19 in communication with the central terminal 16. The kiosk agent 18 may be an employee of the financial services institution, or an employee of a business or other organization that processes money transfer transactions through the financial services institution.

Prior to receiving funds from the manned kiosk 12, the recipient preferably receives pertinent identifying information from the sender. The information may include, but is not limited to, the security code and the PIN, which is issued to the sender by the initiating terminal 11, 13, 14. The recipient presents this information to the kiosk agent 18, and the kiosk agent 18 validates this information as explained below in greater detail. If the information is properly validated, then the kiosk agent 18 will dispense funds to the recipient corresponding to the principal amount.

The system 10 may also have an adjustment system (not shown), such that if the sender changes his mind prior to the recipient receiving the funds, the system can reverse the transaction, with any customary convenience fee potentially forfeited.

Generally, a money transfer transaction according to the invention can be divided into two distinct transactions, an initiating transaction and a dispensing transaction. As those skilled in the art will recognize, the initiating terminal 11, 13, 14 may be referred to as the “issuer” and the central terminal 16 may be referred to as the “acquirer” for purposes of the initiating transaction. With respect to the dispensing transaction, the central terminal 16 is the “issuer” and the manned kiosk 12 is the “acquirer”.

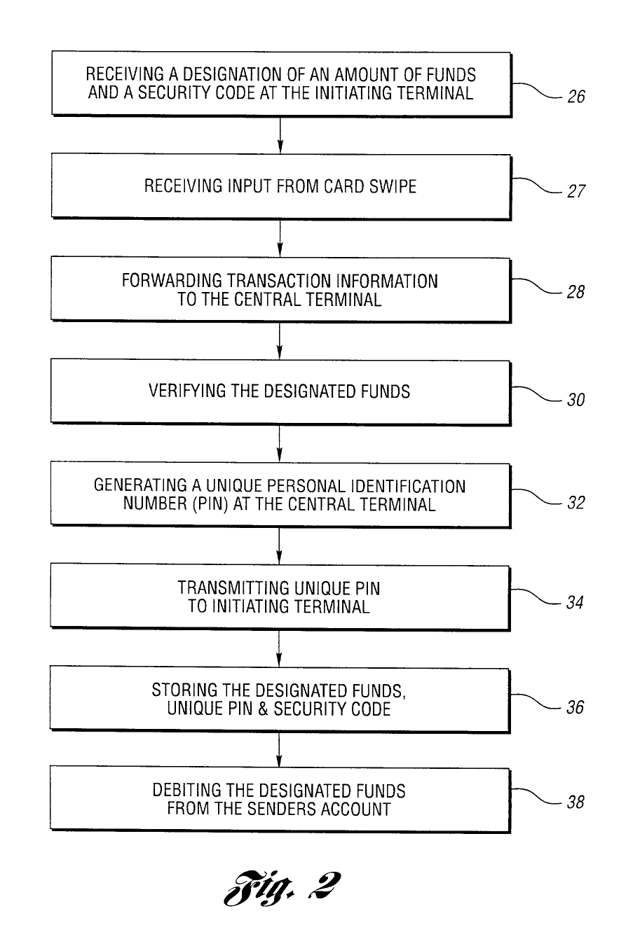

Referring to FIG. 2, method steps of the initiating transaction are illustrated. Generally, the initiating transaction may be divided into three parts: (1) request for transfer; (2) request for authorization; and (3) approval. The initiating transaction begins with a request for a transfer of funds, whereby the sender enters transaction information into the initiating terminal 11, 13, 14. For example, at step 26, the sender designates the amount of funds to be transferred, which may also be referred to as principal amount, and provides a sender-generated security code. The security code is preferably a numeric code that is established by the sender. The security code may, however, comprise one or more alpha-numeric characters, symbols, sounds and/or images. For example, the security code may be the sender's telephone number, the sender's name, or the recipient's name. If the security code is established as an image, such as an image generated by a printer on a piece of paper, then the security code may be scanned into the initiating terminal 11, 13, 14 using a scanning device 20 that may be provided as part of the initiating terminal 11, 13, 14.

Initiating terminal 11, 13, 14 may then request that additional transaction information be input via card swipe at the financial card reader 15, as indicated at step 27. For example, the financial card reader may be used to read account information and/or card identification information from a credit card or debit card. Alternatively, the additional transaction information may be entered into the initiating terminal 11, 13, 14 in any suitable manner, such as by using a keypad. Next, the initiating terminal 11, 13, 14 passes the requested transaction information received from the sender to the central terminal 16 at step 28. At step 30, the initiating terminal 11, 13, 14 sends a request for authorization to the central terminal 16 to verify that the designated funds plus any transaction fee or convenience fee are available for transfer, thereby entering the next stage of the initiating transaction.

With reference again to FIG. 1, a switch 21 of the central terminal 16 accepts the incoming authorization request and activates an authorization unit 22 of central terminal 16. The authorization unit 22 is operative to verify that the sender has sufficient funds in his account to transfer. The central terminal 16 preferably has the appropriate linkages to financial networks (e.g., debit card institutions/issuers, credit card institutions/issuers, etc.) so as to authenticate the card and account information belonging to the sender desiring to transfer funds.

The authorization unit 22 receives the transactional information and determines whether sufficient funds or credit exists. If sufficient funds or credit exists, the authorization unit 22 authorizes the transaction for the full amount of the designated funds and convenience fee. It should be understood that authorization unit 22 may further communicate with an authorization agent such as a financial institution, an intercept processor, a regional/national network or the like in order to authorize the transaction. The system 10 according to the present invention preferably permits customization to thereby allow the participating institutions to set their own approval limits for their customers.

As there are numerous ways for obtaining authorization known in the art, any of which are compatible with the system and method according to the present invention, the actual authorization method carried out by the authorization unit 22 will not be considered in more detail herein. Additional details regarding authorization processes and money transfer transactions are disclosed in U.S. Pat. No. 5,650,604, which is hereby incorporated by reference in its entirety.

Once the authorization unit 22 returns an approval message to central terminal 16, the initiating transaction has entered the approval stage. Once the central terminal 16 receives the approval message, it generates a unique PIN at step 32. Specifically, according to a preferred embodiment of the present invention, after the authorization request is approved, central terminal 16 preferably requests a unique DES-encrypted PIN from encryption module 23, which generates unique numbers based on predetermined security keys. Alternatively, the request for a PIN may be made concurrently with the request for authorization.

Once the PIN has been generated, it is communicated to the sender. The PIN is preferably transmitted to initiating terminal 11, 13, 14, which in turn communicates the PIN to the sender at step 34. The PIN can be provided to the sender via a variety of methods, depending upon the type of initiating terminal 11, 13, 14. For example, an ATM may print out a receipt containing the PIN, the PIN may be displayed visually on a graphical user interface, or it may be provided through a telephone via a VRU. Preferably, a receipt is provided by the initiating terminal 11, 13, 14 itemizing the principal amount transferred, any added fee charged the sender's account for the transaction, if any, and, if the sender has so requested, the system-generated PIN.

Upon receipt of the approval message, the transaction is also journaled or otherwise stored on journal files 24 at step 36. The central terminal 16 also logs the transaction in related databases for later transaction look up as well as for long term storage, retrieval and reporting for subsequent research on that data. The central terminal 16 maintains the transaction in its journal files 24 for later matching activity during the dispensing transaction, as explained below in greater detail. The journal files 24 preferably store at least three pieces of information: 1) the encrypted security code provided by the sender; 2) the system generated PIN associated with the particular transaction; and 3) the designated funds to be transferred.

Once authorization occurs, central terminal 16 debits the sender's account for the designated funds, as well as any convenience fee, at step 38. A convenience fee according to customary business practice is paid by the sender for each money transfer transaction.

As noted earlier, the sender may change his mind and request the transaction be canceled. If the transaction is reversed, the designated funds are returned. System 10 preferably initiates an automatic or immediate reversal as a transaction command. Nevertheless, even if the sender “cancels” the transaction, the system 10 still preferably logs the transaction in its journal files 24.

It should be understood that if a stored value card is used by the sender during the initiating transaction, funds corresponding to the designated funds or principal amount may be immediately acquired from the stored value card. As a result, the authorization steps relative to seeking approval of credit and/or debiting an account may be omitted.

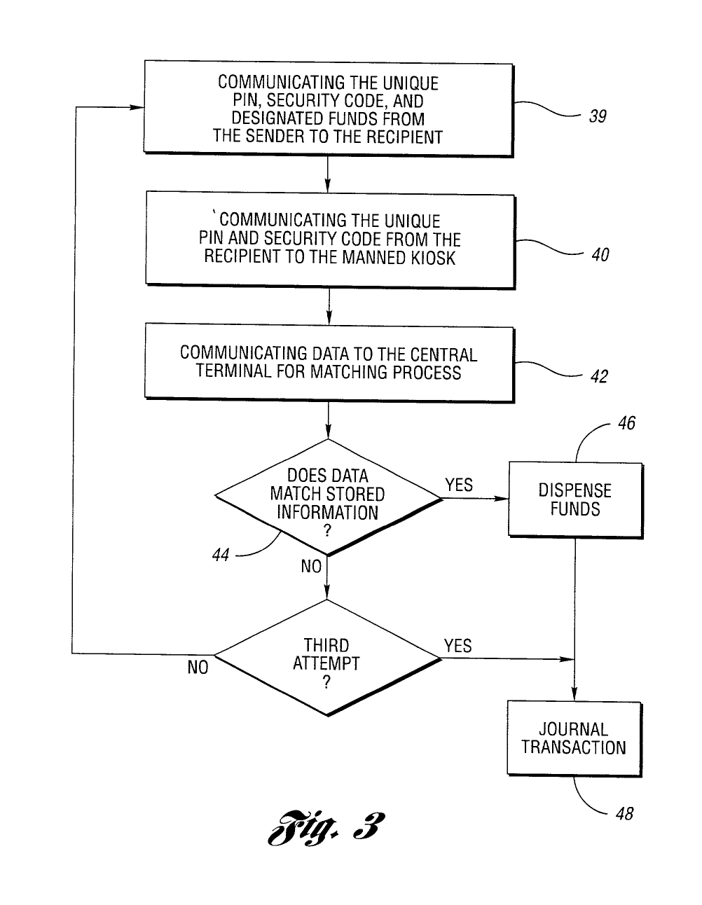

The second transaction, the dispensing transaction, can also be logically considered in three parts: request for authorization, approval, and dispensing of funds to the intended recipient. FIG. 3 illustrates method steps of the dispensing transaction according to a preferred embodiment of the present invention. At step 39, the sender communicates to the recipient the PIN, the security code and the designated funds to be transferred. For example, the sender may provide such information to the recipient via telephone, facsimile or e-mail. At step 40, the recipient communicates or provides the security code and the PIN to the kiosk agent 18 of the manned kiosk 12, thereby entering the request for authorization stage. If the security code is an image, such as an image generated by a printer on a piece of paper, then the security code may be scanned into the dispensing terminal 19 using a scanning device that may be provided as part of the dispensing terminal 19, or is otherwise in communication with the dispensing terminal 19. The kiosk agent 18 then enters this information into the dispensing terminal 19, which encrypts the security code. Next, this information is communicated, at step 42, to central terminal 16. Switch 21 recognizes the transaction as a withdrawal request with a point of service code that instructs central terminal 16 that the request is from a dispensing terminal 19.

Central terminal 16 activates authorization unit 22 to determine whether the requesting recipient is the intended recipient (i.e. entitled to receive the designated funds). At step 44, authorization unit 22 compares the information provided by the recipient to the manned kiosk 12, including the encrypted security code, with the information stored in the journal files 24.

If there is no match, central terminal 16 transmits a message directing the manned kiosk 12 to request that the recipient provide the information again. Once such information has been re-input, dispensing terminal 19 again sends the message to central terminal 16 to determine a match. While this cycle may be repeated as many times as desired, it is preferably repeated only three times before the transaction is terminated.

On the other hand, if there is a match between the information provided by the recipient and that listed within the journal files 24, the authorizing unit 22 issues an authorization approval message to the central terminal 16 indicating that the request for authorization has been approved and directing the agent 18 at the manned kiosk 12 to begin the process of dispensing funds corresponding to the designated funds, as indicated at step 46. The central terminal 16 also logs the transaction in journal files 24, at step 48. Once the transaction has been matched against journal files 24 and the funds have been dispensed, information corresponding to the initiating portion of the transaction is preferably deleted from journal files 24 because both parts of the transaction have been completed. The central terminal 16 then preferably journals the completion of the transaction on the journal files 24. Termination of a transaction due to unsuccessful attempts is also preferably recorded on the journal files 24.

According to another feature of the invention, initiating terminal 11, 13, 14 may be equipped with a cash acceptance mechanism 50 that is configured to accept cash and validate or verify how much has cash has been input. When such an initiating terminal is employed, the authorization steps relative to seeking approval of credit and/or debiting an account, as discussed above in connection with a card-driven initiating terminal, may be omitted.

Because the dispensing transaction is facilitated by the manned kiosk 12, the recipient is provided personal service. Advantageously, the method and system of the invention are especially useful to recipients who may not be familiar with or comfortable with technology associated with money transfer transactions. Furthermore, the manned kiosk 12 may provide various payout options to recipients, such as tickets, traveler's checks, stamps, etc.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for electronically transfering funds between a sender and a recipient comprising:
receiving at an initiating terminal a designation of an amount of funds to be electronically transferred from the sender;
receiving at the initiating terminal a security code from the sender;
generating a unique personal identification number;
providing the unique personal identification number to the sender;
storing the designation of an amount of funds, the security code and the unique personal identification number at a central terminal in communication with the initiating terminal;
providing a manned kiosk including a kiosk agent;
receiving the unique personal identification number and the security code at the manned kiosk from the recipient;
communicating the unique personal identification number and the security code provided by the recipient to the central terminal;
comparing the unique personal identification number and the security code provided by the recipient to the stored unique personal identification number and stored security code at the central terminal; and
dispensing funds corresponding to the designation of an amount of funds at the manned kiosk by the kiosk agent if the unique personal identification number and the security code provided by the recipient match the stored unique personal identification number and the stored security code.

2. The method of claim 1 wherein the step of generating a unique personal identification number comprises generating the unique personal identification number at the central terminal.

3. The method of claim 1 further comprising receiving cash at the initiating terminal corresponding to the designation of an amount of funds.

4. The method of claim 1 further comprising reading a stored value card at the initiating terminal so as to receive funds corresponding to the designation of funds at the initiating terminal.

5. A system for performing an electronic transfer of funds transaction between a sender and a recipient, comprising:
an initiating terminal for receiving a designation of an amount of funds to be electronically transferred from the sender to the recipient, and for receiving a security code from the sender;
a central terminal in communication with the initiating terminal for providing the initiating terminal with a unique personal identification number corresponding to the electronic transfer of funds transaction, and for storing the designation of an amount of funds, the unique personal identification number and the security code; and
a manned kiosk in communication with the central terminal, the manned kiosk including an agent for receiving the unique personal identification number and the security code from the recipient, and for communicating the unique personal identification number and the security code provided by the recipient to the central terminal;
wherein the central terminal is operative to compare the unique personal identification number and the security code provided by the recipient with the stored unique personal identification number and the stored security code, and wherein the manned kiosk is operative to dispense funds corresponding to the designation of an amount of funds directly to the recipient when the unique personal identification number and the security code provided by the recipient match the stored unique personal identification number and the stored security code.

6. The system of claim 5 wherein the initiating terminal further comprises a cash acceptance mechanism for receiving cash corresponding to the designation of an amount of funds.

7. The system of claim 5 wherein the initiating terminal includes a financial card reader for reading information from a stored value card so as to obtain funds corresponding to the designation of an amount of funds.

8. The system of claim 5 wherein the initiating terminal includes a scanning device for receiving the security code from the sender.

9. The system of claim 1 wherein the manned kiosk includes a dispensing terminal in communication with the central terminal, and the dispensing terminal includes a scanning device for receiving the security code.
